(19) United States
(12) Patent Application Publication
(10) Pub. No.: US 2007/0121818 A1
(43) Pub. Date: May 31, 2007

(54) Information processing apparatus, information processing method, and program that enable viewing of content during telephone call

(75) Inventors: Yohei Iwami, Funabashi-shi (JP); Toshiyuki Iwai, Ichihara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/515,861

(22) Filed: Sep. 6, 2006

(30) Foreign Application Priority Data
Sep. 26, 2005 (JP) 2005-277928

(51) Int. Cl. H04M 11/00

(52) U.S. Cl. 379/88.13

(57) ABSTRACT

When content viewed during a telephone call is viewed again, various selecting methods and viewing methods of the content can be achieved. With regard to an information processing apparatus including telephone calling unit such as a television telephone, a content selecting unit that selects content, and a content viewing unit that is used for viewing content, the information processing apparatus includes a phone-call-related information correlation storage unit that stores content viewed at the time of a telephone call and phone-call-related information in a correlated manner. When the content is viewed again after the telephone call, the content can be efficiently selected and viewed by using the stored phone-call-related information to present various selecting methods and reproducing methods of the content to a user with the content selecting unit.

### CROSS-NOTING PARAGRAPH

This Nonprovisional application claims priority under 35 U.S.C. §119 (a) on Patent Application No. 2005-277928 filed in JAPAN on Sep. 26, 2005, the entire contents of which are hereby incorporated herein by references.

### FIELD OF THE INVENTION

The present invention relates to an information processing apparatus, an information processing method, and a program that enables viewing of content while maintaining a telephone call.

### BACKGROUND OF THE INVENTION

Due to the recent improvement in performance of information processing apparatuses and the development of communication technology, various forms of communication and service can be achieved by taking advantage of large-capacity communication.

According to Japanese Laid-Open Patent Publication No. 2003-223407, content such as images and music can be enjoyed while continuing communication. In the invention, a plurality of users can communicate while viewing the same content through a content sharing server.

Due to the improvement in performance of information processing apparatuses, technologies are also developed in relation to viewing and storage of content.

According to Japanese Laid-Open Patent Publication No. 2003-333529, reproduction control intended by a content producer can be achieved by recording particular reproduction control information such as reproduction intended by a content creator or fast forward reproduction, along with content (moving image).

According to Japanese Laid-Open Patent Publication No. 2004-214708, by storing an operation history recording details of user's operation performed for a moving image (content), operationality can be improved when the content is viewed again.

According to Japanese Laid-Open Patent Publication No. 2004-23197, details of a moving image to be viewed can be checked in advance by storing viewed date information and scene switching information in a correlated manner for a moving image (content) and creating a summary of a past viewing state for each user.

The conventional arts create some problems when the content is viewed during a telephone call and the content is viewed again.

For example, if content viewed during a telephone call is stored, it is not known with whom the content was viewed.

Even when a user knows with whom the user talked on a telephone while viewing the content, the story of the content may be forgotten; it may not be known how far the content is viewed; and it may be difficult to remember details of the conversations during the viewing of the content.

If a user wants to view the content viewed during a telephone call again, it is difficult to find the content.

### SUMMARY OF THE INVENTION

An object of the present invention is to provide an information processing apparatus that can present various selecting methods and viewing methods when content is viewed again by storing the content viewed during a telephone call and phone-call-related information in a correlated manner.

Another object of the present invention is to provide an information processing apparatus that includes a telephone calling unit that uses a call to-perform a telephone call, a content viewing unit that is used for viewing content, a phone-call-related information correlation storage unit that stores content viewed at the time of a telephone call and phone-call-related information in a correlated manner, and a phone-call-related information outputting unit that outputs the phone-call-related information correlated with the content when viewing the content stored and correlated with the phone-call-related information stored in the phone-call-related information correlation storage unit.

Using a call to perform a telephone call means that a session is established with an opposite party to perform the telephone call. When the telephone call is terminated, the session is disconnected and terminated. A phone-call indicates one telephone call performed with the use of a call. The present invention is applied to the case of viewing content during a telephone call.

In this description, the content includes images such as moving images and still images, sound such as music and voice, texts, compound documents that are combinations thereof, web pages, games, etc. In this description, viewing the content means that the content is reproduced in a method suitable for each piece of the content and that a user experiences the reproduction (the reproduction of the content), and interaction with the user may be generated by some types of the content such as games.

Therefore, when the content viewed during a telephone call is viewed again, information of a phone-call relating to the content can be output.

A further object of the present invention is to provide the information processing apparatus characterized in that the phone-call-related information is information relating to an opposite party.

Therefore, when the content viewed during a telephone call is viewed again, it can be known with whom the content was viewed during the telephone call.

A further object of the present invention is to provide the information processing apparatus characterized in that the phone-call-related information is information relating to a clock time of the telephone call.

The clock time of the telephone call is of the date and time information relating to the phone-call and is a clock time of starting a telephone call, a clock time of ending a telephone call, a clock time of starting the viewing of the content during the telephone call, a clock time of ending the viewing of the content, etc.

Therefore, when the content viewed during a telephone call is viewed again, it can be known when the content was viewed during the telephone call.

A further object of the present invention is to provide the information processing apparatus characterized in that the phone-call-related information is information relating to details of the telephone call.

The details of the telephone call are voice of conversations made in the phone-call, image and voice of conversations, all conversations made in the telephone call, conversations while viewing the content, conversations before and after viewing the content, etc.

Therefore, when the content viewed during a telephone call is viewed again, details of conversations can be known which are made when viewing the content.

A further object of the present invention is to provide an information processing apparatus that includes a telephone calling unit that uses a call to perform a telephone call, a content viewing unit that is used for viewing content, an operation information correlation storage unit that stores content viewed at the time of a telephone call and operation information describing details of operation performed for the content viewed at the time of the telephone call in a correlated manner, and a content reproducing unit that reproduces the content depending on the operation information correlated with the content when viewing the content stored and correlated with the operation information stored in the operation information correlation storage unit.

Therefore, when the content viewed during a telephone call is viewed again, the operation performed at the time of the telephone call can be reproduced.

The operation means operation performed while viewing the content.

A further object of the present invention is to provide the information processing apparatus characterized in that the operation information describing details of operation performed for the content includes a history of operation performed for the content at the time of a telephone call to apply the operation based on the operation history to reproduce the content when viewing the content stored and correlated with the operation information stored in the operation information correlation storage unit.

The operation history is formed by recording the operation performed while viewing the content in accordance with reproduction positions of the content in time series.

Therefore, when the content viewed during a telephone call is viewed again, the operation performed for the content during the telephone call can be reproduced in the order performed.

Special reproduction can also be performed such that only a portion viewed during the telephone call is reproduced based on a telephone-call history.

A further object of the present invention is to provide the information processing apparatus characterized in that the operation information describing details of operation performed for the content during a telephone call includes operation input by a user of the information processing apparatus to apply the operation to the content and to notify the opposite party of the operation information.

Therefore, when viewing the same content with the opposite party during a telephone call, the operation performed for the content can be transmitted to the opposite party to allow the opposite party to view the content in the same way as one views the content.

A further object of the present invention is to provide the information processing apparatus characterized in that the operation information describing details of operation performed for the content during a telephone call includes operation information notified from the opposite party.

Therefore, when viewing the content during a telephone call, the reproduction can reflect the operation performed by the opposite party to view the content in the same way as the opposite party views the content.

When the content is viewed again, the content can be reproduced in the way allowed by the opposite party based on the operation history notified (transmitted) from the opposite party.

A further object of the present invention is to provide an information processing apparatus that includes a telephone calling unit that uses a call to perform a telephone call, a content viewing unit that is used for viewing content, a correlation storage unit that stores content viewed at the time of a telephone call and phone-call-related information in a correlated manner, and an extracting unit that extracts content corresponding to the phone-call-related information depending on the phone-call-related information.

Therefore, when selecting the content to be reproduced, the content can be selected based on information of the phone-call.

A further object of the present invention is to provide an information processing apparatus that includes a telephone calling unit that uses a call to perform a telephone call, a content viewing unit that is used for viewing content, a correlation storage unit that stores content viewed at the time of a telephone call and phone-call-related information in a correlated manner, and an extracting unit that extracts the phone-call-related information correlated with the content depending on the content.

Therefore, when viewing the content, information of the content can be known such as in what phone-call the content was viewed or with whom the content was viewed.

A further object of the present invention is to provide the information processing apparatus that includes a selecting unit that selects the content extracted by the extracting unit depending on the phone-call-related information and a reproducing unit that reproduce the content selected by the selecting unit.

A further object of the present invention is to provide the information processing apparatus characterized in that the phone-call-related information is information relating to an opposite party.

A further object of the present invention is to provide the information processing apparatus characterized in that the phone-call-related information is information relating to a clock time of the telephone call.

A further object of the present invention is to provide the information processing apparatus characterized in that the phone-call-related information is information relating to details of the telephone call.

A further object of the present invention is to provide an information processing method that includes a telephone calling step of using a call to perform a telephone call, a content viewing step of viewing content, a phone-call-related information correlation storage step of storing content viewed at the time of a telephone call and phone-call-related information in a correlated manner, and a phone-call-related information output step of outputting the phone-call-related information correlated with the content when viewing the content stored and correlated with the phone-call-related information stored at the phone-call-related information correlation storage step.

A further object of the present invention is to provide an information processing method that includes a telephone calling step of using a call to perform a telephone call, a content viewing step of viewing content, an operation information correlation storage step of storing content viewed at the time of a telephone call and operation information describing details of operation performed for the content viewed at the time of the telephone call in a correlated manner, and a content reproducing step of reproducing the content depending on the operation information correlated with the content when viewing the content stored and correlated with the operation information stored at the operation information correlation storage step.

A further object of the present invention is to provide an information processing method that includes a telephone calling step of using a call to perform a telephone call, a content viewing step of viewing content, a correlation storage step of storing content viewed at the time of a telephone call and phone-call-related information in a correlated manner, and an extracting step of extracting content corresponding to the phone-call-related information depending on the phone-call-related information.

A further object of the present invention is to provide an information processing method that includes a telephone calling step of using a call to perform a telephone call, a content viewing step of viewing content, a correlation storage step of storing content viewed at the time of a telephone call and phone-call-related information in a correlated manner, and an extracting step of extracting the phone-call-related information correlated with the content depending on the content.

A further object of the present invention is to provide the information processing method that includes a selecting step of selecting the content extracted at the extracting step depending on the phone-call-related information and a reproducing step of reproducing the content selected at the selecting step.

A further object of the present invention is to provide a program for executing an information processing method with a computer.

### BRIEF DESCRIPTION OF THE DRAWINGS

FIG. 1 is a diagram for describing one embodiment of a system to which the present invention is applied.

FIG. 2 is a block diagram of a relevant outline configuration for describing one embodiment of an information processing apparatus according to the present invention.

FIG. 3 is a flowchart for describing a process executed when viewing content at the time of a telephone call in the information processing apparatus according to the present invention.

FIG. 4 is a flowchart for describing a process of selecting and reproducing content in the information processing apparatus according to the present invention.

FIG. 5 is a diagram for describing data stored in a phone-call-related information correlation storage unit in the information processing apparatus according to the present invention.

FIG. 6 is a diagram for describing data relating to an operation history among the data shown in FIG. 5.

FIG. 7 shows an example of a screen displayed when a user selects content in the information processing apparatus according to the present invention.

FIG. 8 shows an example of a screen displayed when a user selects content in the information processing apparatus according to the present invention.

FIG. 9 shows an example of a screen displayed when a user selects a content reproducing method in the information processing apparatus according to the present invention.

FIG. 10 is a diagram for describing a reproduction schedule created based on the reproducing method selected by the user.

FIG. 11 shows an example of a screen displayed when a user selects content in the information processing apparatus according to the present invention.

FIG. 12 shows an example of a screen displayed when a user selects content and determines a process to be executed after selecting the content in the information processing apparatus according to the present invention.

FIG. 13 shows an example of a screen displayed when a user selects content and selects a telephone call destination after selecting the content in the information processing apparatus according to the present invention.

FIG. 14 shows an example of a screen displayed when a user selects content and selects a process of reproduction after selecting the content in the information processing apparatus according to the present invention.

FIGS. 15A to 15E are diagrams-for describing methods for realizing various reproducing methods of content.

FIG. 16 is a block diagram of a relevant outline configuration for describing one embodiment of the information processing apparatus according to the present invention.

FIG. 17 is a flowchart that describes a process of sharing content with an opposite party during a telephone call in the information processing apparatus according to the present invention.

FIG. 18 is a flowchart that describes a process executed when content is shared with an opposite party during a telephone call to view the content in the information processing apparatus according to the present invention.

FIG. 19 is a flowchart for describing a process of selecting content correlated with an opposite party in the information processing apparatus according to the present invention.

FIG. 20 shows a screen for selecting content correlated with an opposite party.

FIG. 21 shows a screen for selecting a process to be executed after selecting content.

FIG. 22 shows a screen for selecting content shared and viewed during a telephone call.

FIG. 23 is a diagram for describing phone-call-related information.

### PREFERRED EMBODIMENTS OF THE INVENTION

### First Embodiment

In the present invention, it is intended that a plurality of users views content during a telephone call, stores information relating to the telephone call in a correlated manner, and views (reproduces) the content later based on the stored related information.

In the following description, for the sake of simplicity, in the situation that two users A and B use an information processing apparatus A and an information processing apparatus B, respectively, for a telephone call and the user B views content during the telephone call, it is assumed that information relating to the telephone call is stored and correlated with the content in the information processing apparatus B and that the stored information is used for reproduction later when the user B reproduces the content viewed during the telephone call with the user A.

The plurality of users is not limited to two users and the embodiment is applied to three or more users.

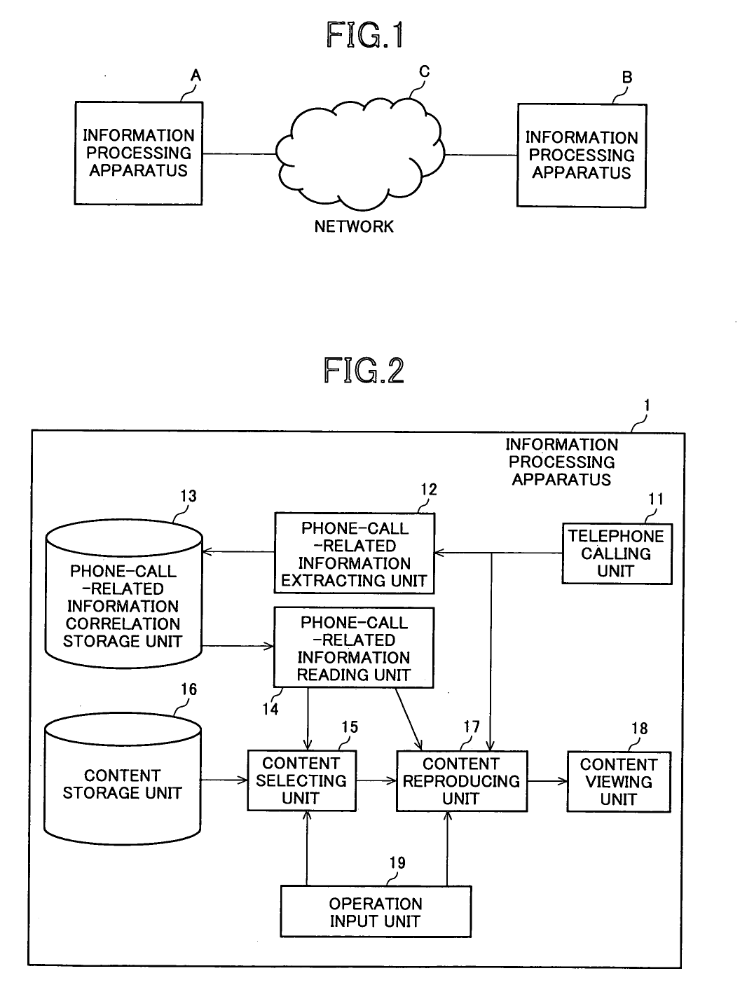

FIG. 1 shows a configuration necessary when the user A and the user B use the information processing apparatus A and the information processing apparatus B, respectively, to perform a telephone call and to view content.

The information processing apparatus A used by the user A and the information processing apparatus B used by the user B are connected through a network C.

The network C may be any network lines such as telephone lines, LAN, and Internet lines.

FIG. 2 is a block diagram of a relevant outline configuration for describing one embodiment of an information processing apparatus according to the present invention and, in FIG. 2, a reference numeral 1 is an information processing apparatus according to the present invention. The information processing apparatus 1 includes a telephone calling unit 11, a phone-call-related information extracting unit 12, a phone-call-related information correlation storage unit 13, a phone-call-related information reading unit 14, a content selecting unit 15, a content storage unit 16, a content reproducing unit 17, a content viewing unit 18, an operation input unit 19, etc.

The telephone calling unit 11 performs a telephone call with other information processing apparatuses connected to the network via a telephone line or VoIP (Voice over IP), etc. That is, the telephone calling unit 11 sends signals to a specified calling destination and establishes connection to transmit and receive voice and images. The telephone calling unit 11 accepts telephone call information in response to a connection request from an opposite party to transmit and receive voice and images. The telephone calling unit 11 includes a storage unit used for registering calling destinations, a camera and microphone that input and output voice and images, a display screen, etc.

The phone-call-related information extracting unit 12 extracts information relating to a telephone call from the telephone calling unit 11, correlates the information with content viewed with the content viewing unit 18, and stores the information into the phone-call-related information correlation storage unit 13.

The phone-call-related information may be various pieces of information such as information relating to an opposite party, information relating to a clock time, information relating to a conversation, information relating to operation, or information of a home network or information of a sensor at the time of a telephone call.

Information relating to operation performed for the content may be transmitted as content operation information along with content reproduction information by the content reproducing unit 17 and may be stored as an operation history that is correlated with a reproduction position where the operation is performed.

The phone-call-related information correlation storage unit 13 stores the phone-call-related information extracted and correlated with the content by the phone-call-related information extracting unit 12.

The phone-call-related information reading unit 14 extracts the phone-call-related information correlated with the content from the phone-call-related information correlation storage unit 13.

The content selecting unit 15 uses the phone-call-related information correlated with the content and read by the phone-call-related information reading unit 14 to prompt a user to select the content stored in the content storage unit 16 and delivers information necessary for reproducing the content selected by the user to the content reproducing unit 17.

The content selecting unit 15 includes a function that creates UI (User Interface) presented to the user, uses the phone-call-related information to sort and display the content based on arbitrary information among the phone-call-related information in the case of content list display, displays a plurality of content selecting methods when the user selects the content, provides links from incoming and outgoing call history screens such that the content can be selected, enables selection of the content viewed in a telephone call with a certain person (registered in the address book), and can present various content reproducing methods to the user with the use of the operation history.

The content storage unit 16 stores an entity of the content or information about the location of the content.

The content may be stored inside or outside of the information processing. The content stored outside is content stored in servers on the internet or devices connected to a home network. The home content can be viewed with the use of a DLNA (Digital Living Network Alliance) mechanism, for example. If the content is stored outside, the information stored in the content storage unit 16 is URLs (Uniform, Resource Locators), etc.

If the content is stored within the information processing apparatus, the information stored in the content storage unit 16 is file paths, etc.

The content reproducing unit 17 acquires the content selected by the content selecting unit 15 from the content storage unit 16, acquires or creates the reproducing method selected by the content selecting unit 15 based on the phone-call-related information acquired from the phone-call-related information reading unit 14, and reproduces the content with the content viewing unit 18. The content reproducing unit 17 outputs the phone-call-related information read by the phone-call-related information reading unit 14 with the content viewing unit 18 in accordance with the reproduction of the content.

The content reproducing unit 17 changes the reproduction process in accordance with operation input from the operation input unit 19 by the user and displays the process with the content viewing unit 18. The content reproducing unit 17 notifies the phone-call-related information extracting unit 12 of the input operation along with the content reproduction information.

The content reproducing methods include a reproducing method of simply reproducing the content, i.e., so-called normal reproduction and a special reproducing method of reproducing the content in accordance with a reproduction schedule created with the use of the operation history stored in the phone-call-related information. The special reproducing method includes, for example, duplicating reproduction that performs reproduction by completely duplicating a viewing method at the time of a telephone call, digest reproduction that reproduce a reproduced portion only, a reproducing method of viewing only a portion not viewed, resume reproduction that reproduces the continuation of a portion viewed during a telephone call, and duplicating reproduction that reproduces images and voice of conversations made when viewing the content at the same time.

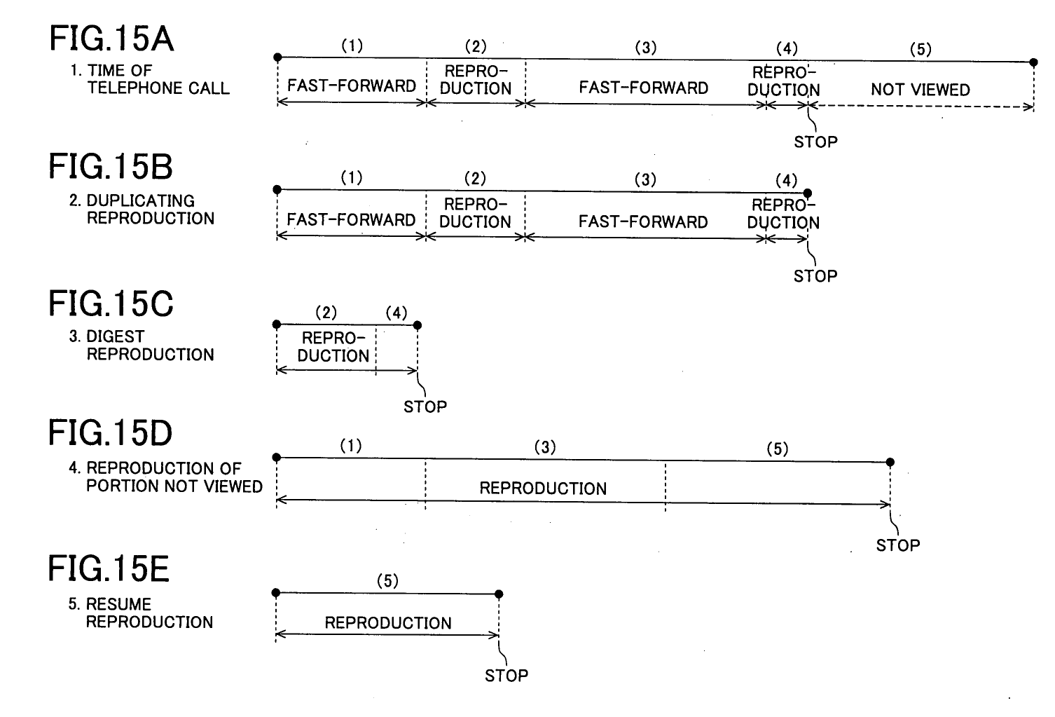

FIGS. 15A to 15E are diagrams for describing examples of realizing the aforementioned special reproducing method with the use of the operation history.

FIG. 15A shows the reproduction history at the time of the viewing of the content along with the content positions. FIG. 15A shows that a viewer fast-forwards a portion of (1) of the content, reproduces a portion of (2), fast-forwards a portion of (3), reproduces a portion of (4), stops at the end of (4), and does not view a portion of (5) at the time of a telephone call.

Description will be made of the reproducing methods when a user views the content in this way with reference to FIGS. 15B to 15E.

FIG. 15B is a diagram for describing a method of realizing the duplicating reproduction. The duplicating reproduction fast-forwards (1) of the content, reproduces (2), fast-forwards (3), reproduces (4), and stops. The duplicating reproduction faithfully duplicates the reproducing method at the time of the telephone call, i.e., the reproduction history shown in FIG. 15A. The duplicating reproduction does not reproduce the portion of (5), which was not viewed.

The duplicating reproduction can directly duplicates how the content was viewed at the time of the telephone call, and the user can easily remember the details of the content and the story associated with the content.

FIG. 15C is a diagram for describing a method of realizing the digest reproduction. The digest reproduction reproduces only the portions reproduced during the telephone call. Therefore, as shown in FIG. 15C, the digest reproduction can be realized by interlinking and reproducing the portions of (2) and (4).

When a user wants to view only the portions viewed during the telephone call, the user can easily view the content by performing the digest reproduction.

FIG. 15D is a diagram for describing a method of reproducing portions not viewed. To reproduce the portion not viewed, reproduction is performed for portions other than the portions reproduced at the time of the telephone call. Therefore, the portions of (1) and (3) fast-forwarded at the time of the telephone call and the portion of (5) not viewed are interlinked and reproduced.

By viewing the portion not viewed at the time of the telephone call, only the portions not viewed previously can be easily viewed at the time of the next telephone call.

FIG. 15E is a diagram for describing a method of realizing the resume reproduction. In the resume reproduction, the continuation of the portion viewed at the time of the telephone call is viewed. Since the viewing is stopped at the end of (4) at the time of the telephone call, the resume reproduction reproduces the portion of (5).

In the resume reproduction, the user can easily view the continuation of the portion of the content viewed at the last telephone call.

The content viewing unit 18 displays the content reproduced by the content reproducing unit 17. The content viewing unit 18 includes a display apparatus such as a liquid crystal display and a CRT display and an audio output apparatus such a speaker.

The display apparatus and the audio output apparatus may be the same screen and speaker used by the communicating unit 11 to output voice and images.

The operation input unit 19 is used to input the operation from the user to the apparatus. Specifically, the operation input unit 19 is an input device such as a button attached to the apparatus, a remote controller, or a touch panel.

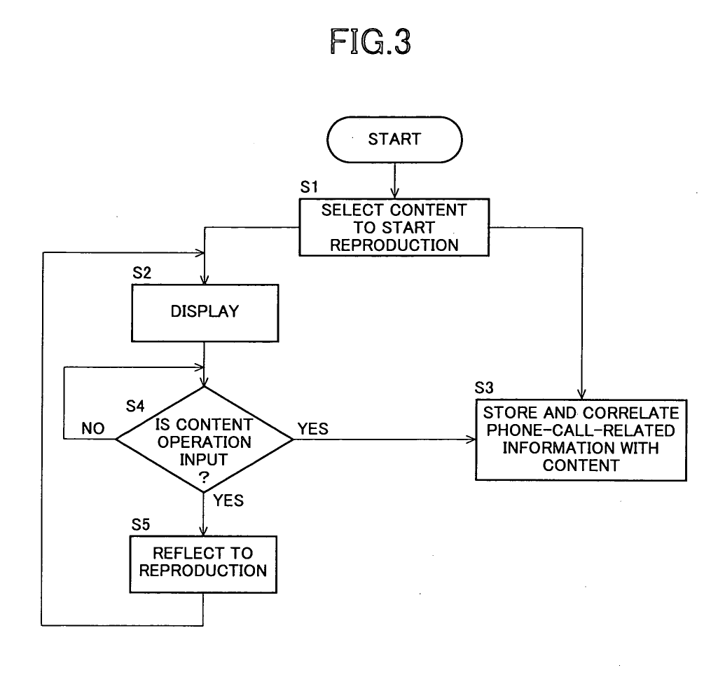

FIG. 3 is a flowchart for describing a process of viewing the content at the time of a telephone call and storing and correlating the phone-call-related information with the content in the information processing apparatus A and the information processing apparatus B.

First, the content selecting unit 15 selects content and the content reproducing unit 17 starts reproduction during a telephone call (step S1).

The reproduced content is output from the content viewing unit 18, and the users can enjoy the content (step S2).

Concurrently with the process at step S2, the phone-call-related information extracting unit 12 extracts the phone-call-related information from the telephone calling unit 11 and stores (saves) and correlates the information with the content in the phone-call-related information correlation storage unit 13 (step S3).

When operation for the content is performed from the operation input unit 19 for the content during the reproduction (YES at step S4), the content reproducing unit 17 reflects the input operation to the reproduction (step S5).

Concurrently with the process at step S4 (YES at step S4), the content reproducing unit 17 transmits the input operation and the reproduction position information of the content to the phone-call-related information extracting unit 12, and the phone-call-related information extracting unit 12 creates and stores a telephone call history into the phone-call-related information correlation storage unit 13.

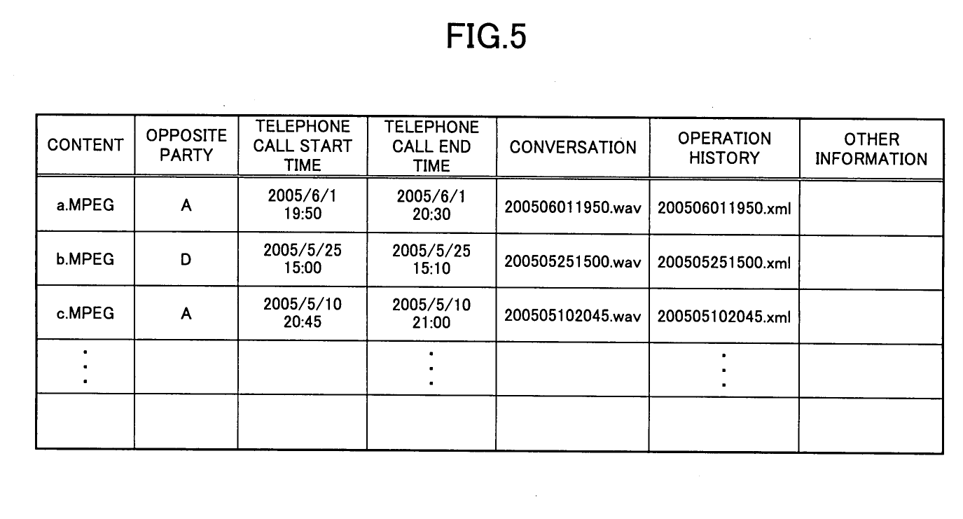

FIG. 5 is a diagram for describing the phone-call-related information stored in the phone-call-related information correlation storage unit 13.

FIG. 5 shows an example of the phone-call-related information stored in the phone-call-related information correlation storage unit 13 in the information processing apparatus used by the user B, and the phone-call-related information correlation storage unit 13 stores content names, opposite parties, telephone call start times, telephone call end times, conversations, operation histories, and other pieces of information in a correlated manner.

The information stored for content, a.MPEG, indicates that the opposite party is the user A, that the telephone call start time is Jun. 1, 2005 at 19:50, that the telephone call end time is Jun. 1, 2005 at 20:30, that the conversations are stored in an audio file, 200506011950.wav, and that the operation history is stored in an xml file, 200506011950.xml.

Although the opposite party name, the telephone call start time, the telephone call end time, the conversation, the operation history, and other pieces of information are stored in a correlated manner in FIG. 5, other pieces of information stored may be various pieces of information, as described above, which may be information relating to an opposite party such as an address and a telephone number of an opposite party; information relating to a clock time such as a clock time when viewing of the content is started or when viewing of the content is ended; information relating to a conversation such as images and voice of the conversation and the content viewed before and after the conversation; information of a home network such as a usage clock time of an interphone during the telephone call; information of a viewer's body temperature or motion obtained by using a temperature sensor or a motion sensor, which is used as a usage status sensor information of bath; or news headlines at the clock time of the telephone call.

The stored information may not necessarily be the entity of the information and may be information indicating a location where the information is stored.

Although the content is only the MPEG files in this example, the content may be moving images such as MPEG 1 and 2, AVI, H.264, and DVI; still images such as JPEG, BMP, GIF, and PNG; sound such as wav, mp3, aac, and ac3; or various types of content such as game data, TV broadcasting, web pages, and internet contents offered by internet service providers. The contents may be the accumulated contents stored in the content storage unit 16 of the information processing apparatus 1 or the un-accumulated contents, for example, streaming contents. The contents may be a combination of these contents.

Although wav is used as the storage format of the conversations, other various audio file formats may be used.

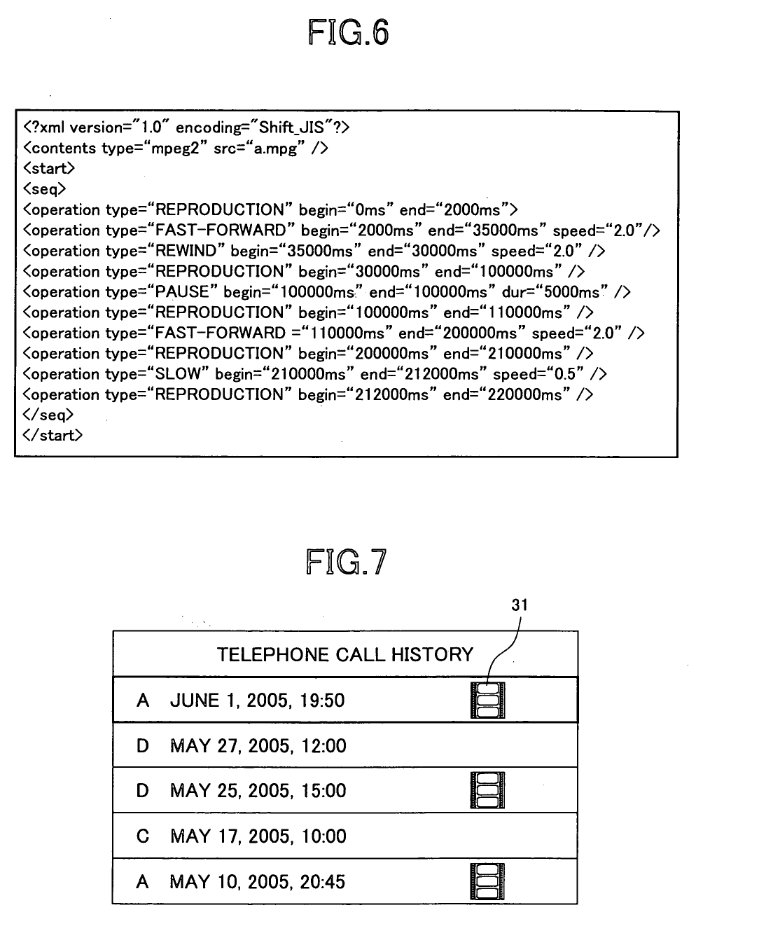

FIG. 6 shows how the operation history of the content viewed by the user B during the telephone call with the user A is stored in the information processing apparatus B using an xml file. The operation information of the content and the reproduction position of the operated content delivered from the content reproducing unit 17 are described in the xml format as shown in FIG. 6. This file describes a content name (<contents type=“mpeg2” src=“a.mpg”/>) and the operation performed at the time of reproduction in time series. This file indicates the operation of reproducing from 0 second to 2 second (<operation type=“reproduction” begin=“0ms” end=“2000ms”/>), fast-forwarding from 2 second to 35 second (<operation type=“fast-forward” begin=“2000ms” end=“35000ms” speed=“2.0”/>), rewinding from 35 second to 30 second (<operation type=“rewind” begin=“35000ms” end=“30000ms” speed=“2.0”/>), reproducing from 30 second to 100 second (<operation type=“reproduction” begin=“30000ms” end=“100000ms”/>), suspending at 100 second for 5 seconds (<operation type=“suspend” begin=“100000ms” end=“1000000ms” dur=“5000ms”/>), reproducing from 100 second to 110 second (<operation type=“reproduction” begin=“10000ms” end=“110000ms”/>), fast-forwarding from 110 second to 200 second (<operation type=“fast-forward” begin=“110000ms” end=“200000ms” speed=“2.0”/>), reproducing from 200 second to 210 second (<operation type=“reproduction” begin=“200000ms” end=“210000ms”/>), reproducing at a slow speed from 210 second to 212 second (<operation type=“slow” begin=“210000ms” end=“212000ms” speed=“0.5”/>), reproducing from 212 second to 220 second (<operation type=“reproduction” begin=“212000ms” end=“220000ms”/>), and stopping at 220 second.

Although the content reproduction position is represented by relative time from the beginning of the content in this example, the reproduction position may be a frame number or ID at the time of the operation in the case of a moving image or may be a name of a displayed file in the case of a still image.

Although the general operations such as fast-forward, reproduction, stop, slow, and rewind are described as the operations in this example, any operations performed for the content may be stored, such as “frame advance”; “scaling”; “pointing” that points somewhere on the screen; “determination” used when following a link or selecting a menu; “next/previous” performed in a slide show of still images, etc.; “print”; “graffiti” that writes graphics on the screen; “setup” for volume adjustment and the brightness and position of the screen; “snapshot” that stores a displayed screen as a still image; “special effects” that adds effects such as sepia or mosaic to the viewed image; and operations for selecting BGM of a slide show or transition effects when switching a screen. In such a case, details (operation information) in accordance with each operation are described in the operation history shown in FIG. 6.

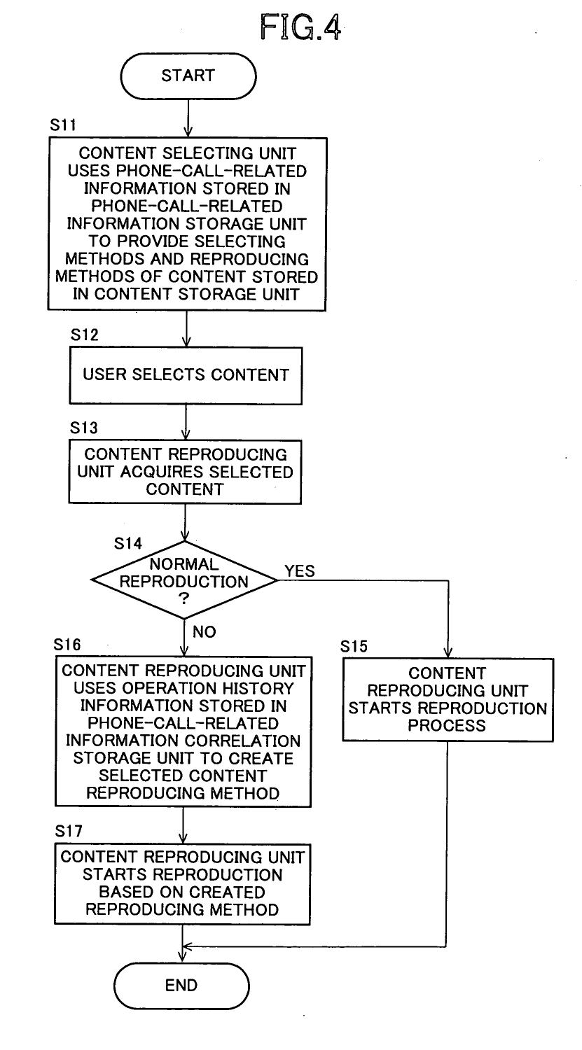

FIG. 4 is a flowchart for describing a process when viewing content in the information processing apparatus A and the information processing apparatus B.

The content selecting unit 15 presents to the user the selecting methods for selecting the content stored in the content storage unit 16 (step S11). Various selecting method can be presented to the user by using the phone-call-related information stored in the phone-call-related information correlation storage unit 13.

When the user inputs the content determination operation (operation for determining the content that the user wants to view) from the operation input unit 19 (step S12), the content reproducing unit 17 acquires the content selected by the content selecting unit 15 (step S13) The content reproducing unit 17 determines whether the reproducing method of the selected content is the normal reproduction and if the method is the normal reproduction (YES at step S14), the content reproducing unit 17 starts the content reproduction process (step S15).

If the method is not the normal reproduction (NO at step S14), the content reproducing unit 17 creates the selected content reproduction method from the operation history information correlated with the content read by the phone-call-related information reading unit 14 (step S16).

The content reproducing unit 17 starts the content reproduction process based on the created content reproduction method (step S17).

FIGS. 7, 8, and 9 are diagrams for describing examples of the content selecting method and the content reproducing methods. FIGS. 7, 8, and 9 describe the case that the user B refers to the telephone call history to select and view the content viewed during a telephone call with the user A on Jun. 1, 2005, when the phone-call-related information is stored in the phone-call-related information correlation storage unit 13 as shown in FIG. 5.

FIG. 7 is a display screen of the phone-call history and the screen displays opposite parties, times and dates of telephone calls, and icons. If the phone-call-related information correlation storage unit 13 stores the phone-call-related information for each phone-call, the content selecting unit 15 uses icons 31 to indicate that the content correlated with the opposite parties (A, D) exists.

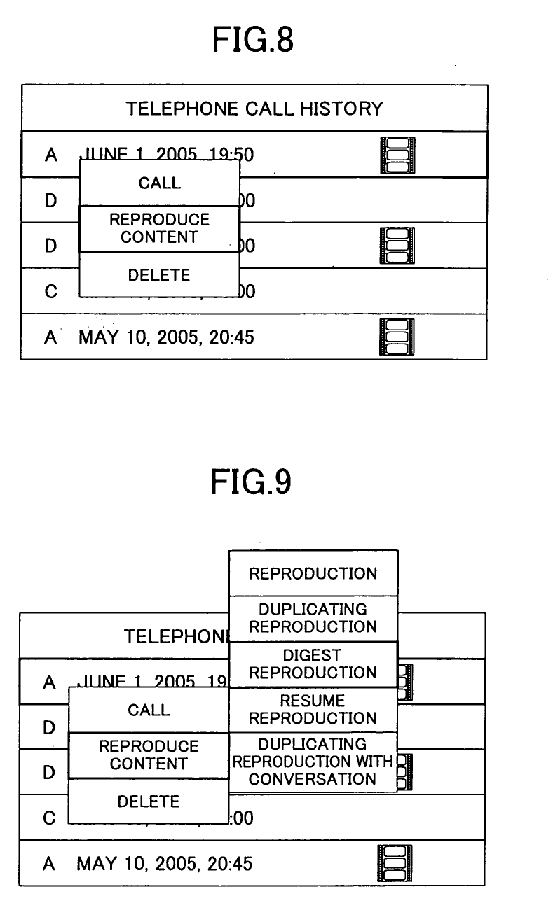

FIG. 8 shows a screen when the user B selects the telephone call made on Jun. 1, 2005 with the user A from the telephone call history after the screen of FIG. 7 is displayed.

When the phone-call (telephone call history for A) is selected, the user can select to: (1) call the opposite party of the phone-call (A); (2) delete the phone-call history; or (3) reproduce the content correlated with the phone-call.

FIG. 9 shows a screen when “content reproduction” is selected by the user B in FIG. 8. The content selecting unit 15 uses the phone-call-related information stored in the phone-call-related information correlation storage unit 13 to display a list of reproducing methods that can be achieved.

Options presented to the user are: (1) “reproduction” that reproduces the content normally; (2) “duplicating reproduction” that duplicates the reproducing method at the time of the phone-call; (3) “digest reproduction” for viewing the portion viewed at the time of the phone-call; (4) “resume reproduction” that reproduces the continuation of the portion viewed during the selected phone-call; and (5) “duplicating reproduction with conversations” that simultaneously reproduces conversations made with the opposite party during the phone-call at the time of the duplicating reproduction, and the user can select a method from these five methods.

When the user selects a reproducing method (“digest reproduction” is selected in FIG. 9), the content reproducing unit 17 notifies a reproducing means of the information, for example, a file path identifying the content stored in the content storage unit 16, the selected reproducing method, and the phone-call. The content reproducing unit 17 acquires the content from the content storage unit 16 and the operation history from the phone-call-related information correlation storage unit 13 based on the notified phone-call and the information identifying the content.

In this example, the content reproducing unit 17 acquires the content that is the a.MPEG and the operation history that is 200506011950.xml. The content reproducing unit 17 creates a reproduction schedule based on the selected reproduction method.

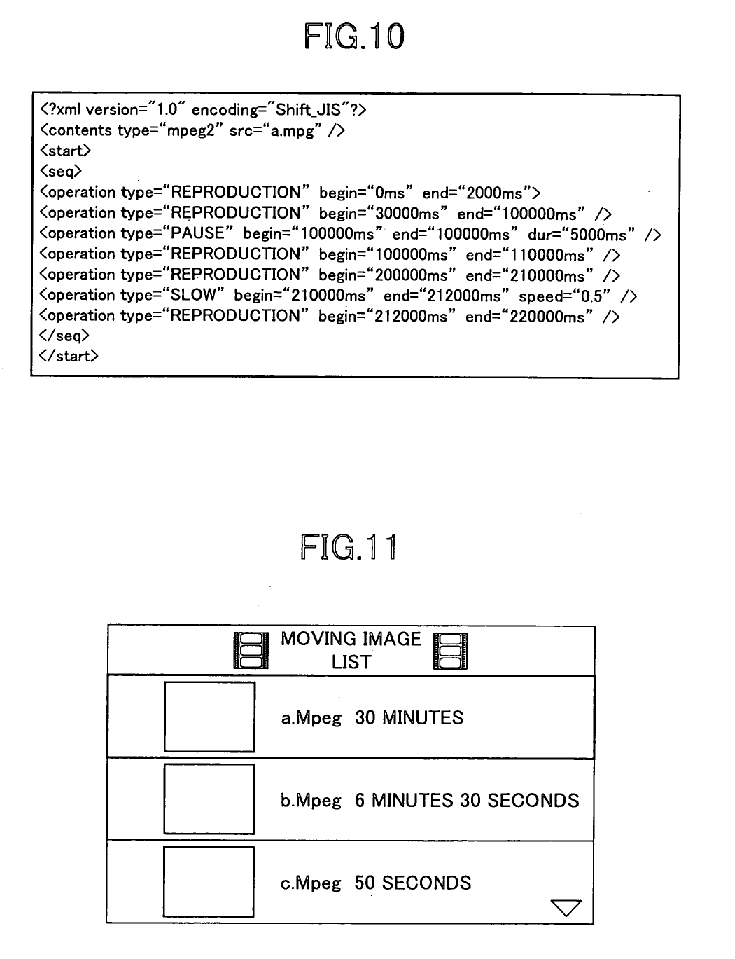

FIG. 10 shows a description example of the reproduction schedule created by the content reproducing unit 17 for the digest reproduction selected from the reproducing method selection screen list of FIG. 9.

The digest reproduction is realized by using the method of FIG. 15C described above. In this case, the digest reproduction is selected from the reproducing methods in the case of viewing in the phone-call selected in FIG. 7. The digest reproduction is to collect and reproduce the portions noticed and viewed by the viewer, such as reproduced scenes, suspended scenes, and portions reproduced at a slower speed.

The content reproducing unit 17 extracts and interlinks the reproduced portions, the suspended portions, and the portions reproduced at a slower speed from the operation history of FIG. 6to create the reproduction schedule. In this case, the reproduction is performed by reproducing from 0 second to 2 second and 30 second to 100 second, suspending at 100 second for 5 seconds, reproducing from 100 second to 110 second and 200 second to 210 second, reproducing at a slower speed from 210 second to 212 second, reproducing from 212 second to 220 second, and stopping at 220 second.

Transition effects, etc., may be added at the moment of jumping between the reproduction positions.

The reproduction schedule is created in this way and the digest reproduction is performed for the a.MPEG.

FIGS. 11, 12, 13, and 14 are diagrams for describing a process when the user select a reproducing method from a plurality of reproducing methods and show a series of selection screens displayed when the user B views the content, a.MPEG, until the user B performs the digest reproduction of the content (a.MPEG) viewed in the telephone call on Jun. 1, 2005 with the user A.

FIG. 11 shows a screen when the content selecting unit 15 displays a list of the content stored in the content storage unit 16 of the information processing apparatus B.

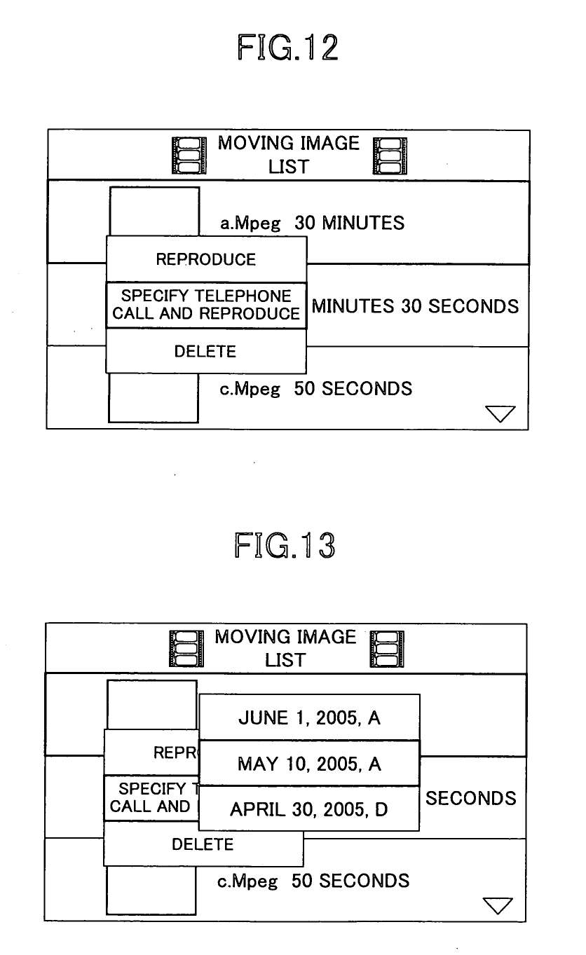

FIG. 12 shows a screen when the user B selects the a.MPEG from the moving image list in FIG. 11. The user B can select to reproduce the content (reproduction of FIG. 12), to use the phone-call-related information stored and correlated with this content in the phone-call-related information correlation storage unit 13 to reproduce the content (telephone call specified reproduction of FIG. 12), or to delete the content (deletion of FIG. 12).

FIG. 13 shows a screen when the user B selects the telephone call specified reproduction in FIG. 12. The content selecting unit 15 extracts the phone-call correlated with the a.MPEG from the phone-call-related information correlation storage unit 13. In this case, the content was viewed in three phone-calls, and the dates (dates of the telephone calls) and the opposite parties of the phone-calls are displayed in a list.

The display may include time information; only five recent items may be displayed if the correlated phone-calls are too many to display on the screen; or after a list of opposite parties is displayed and an opposite party is selected, the phone-call list of the opposite party may be displayed.

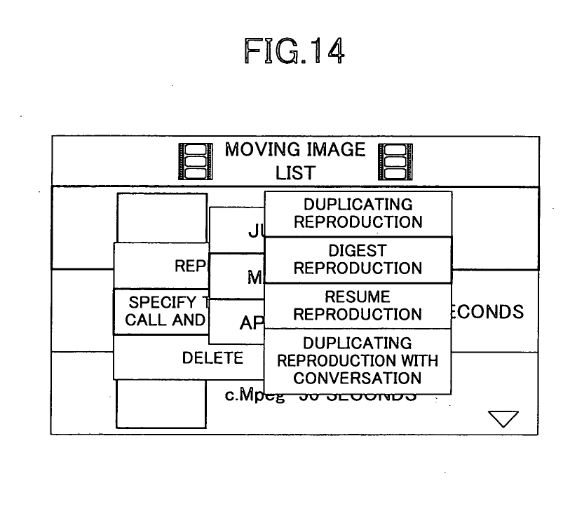

FIG. 14 shows a screen when the user selects a phone-call with a person A on May 10, 2005 in FIG. 13. When the phone-call with the person A is selected, a list is displayed to show the reproducing methods that can be created from the phone-call-related information stored and correlated with the selected phone-call for the content in the phone-call-related information correlation storage unit 13. In this example, the reproducing methods same as those shown in FIG. 9 can be selected.

If the user selects the digest reproduction, the content reproducing unit 17 creates and reproduces the reproduction schedule described in FIG. 10.

In the examples of FIGS. 7 to 14, description has been made of the example that the content is reproduced by selecting the content viewed in a certain phone-call with a certain person (opposite party) from the telephone call history with the use of the telephone call start times and the opposite parties included in the phone-call-related information shown in FIG. 5 and by selecting an arbitrary reproducing method from a plurality of reproducing methods created with the use of the conversations and the operation history and the example that the content is selected from a content list to select an arbitrary reproducing method from a plurality of reproducing methods created with the use of the phone-call in which the content was viewed, the conversations, and the operation history.

Various pieces of information may be stored for other information as described in FIG. 5. By using various pieces of information, for example, a content viewing start time and information relating to a usage time of an interphone can be used to reproduce only a portion reproduced while using the interphone and to view a portion that could not be viewed.

For example, by using the content viewing start time and conversation information during a telephone calling to reproduce conversations made before and after viewing the content, the user can know the background of the viewing of the content, impressions of the viewed content, etc.

For example, by using information of content viewed before and after viewing content, associated content can be selected when selecting content.

For example, by using information of a temperature sensor or motion sensor, a portion with increased temperature or active motion can be determined as an exciting portion and when the content is viewed again, an indication can be made to the user with regard to a portion where the user was excited in the previous telephone call.

### Second Embodiment

In the first embodiment, description has been made of the embodiment that stores content and the phone-call-related information in a correlated manner when the content is viewed during a telephone call to realize various types of a selecting means and the reproducing means when the content is viewed again later.

Description will hereinafter be made of an embodiment of applying the present invention when the user talks on the phone while sharing and viewing the content with an opposite party.

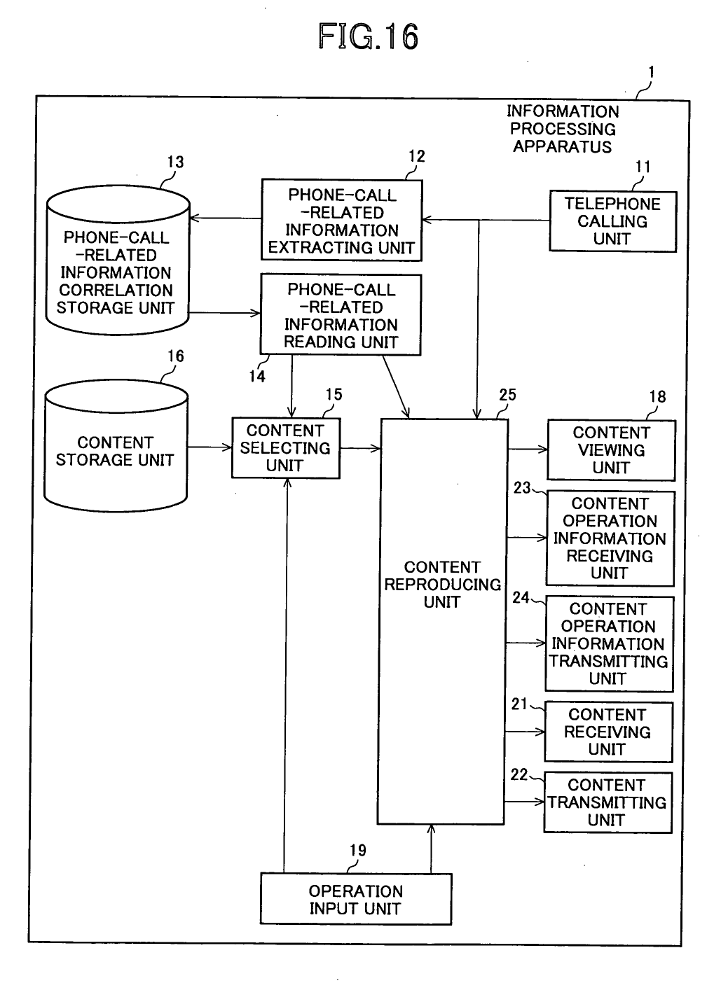

FIG. 16 is a block diagram of a relevant outline configuration for describing one embodiment (sharing and viewing the content during a telephone call with an opposite party) of an information processing apparatus according to the present invention and, in FIG. 16, a reference numeral 1 is an information processing apparatus according to the present invention. The information processing apparatus 1 includes the telephone calling unit 11, the phone-call-related information extracting unit 12, the phone-call-related information correlation storage unit 13, the phone-call-related information reading unit 14, the content selecting unit 15, the content storage unit 16, the content viewing unit 18, the operation input unit 19, a content receiving unit 21, a content transmitting unit 22, a content operation information receiving unit 23, a content operation information transmitting unit 24, a content reproducing unit 25, etc.

The content receiving unit 21 receives the content from the opposite party when sharing and viewing the content of the opposite party.

The content transmitting unit 22 transmits the content to the opposite party when sharing and viewing the own content.

The content operation information receiving unit 23 receives the operation information notified from the opposite party when the operation is input for the content shared and viewed with the opposite party on the opposite party side.

The content operation information transmitting unit 24 transmits the operation information to the opposite party when the operation is input for the content shared and viewed with the opposite party on the own side.

The content receiving unit 21 and the content transmitting unit 22 may transmit and receive information relating to the content reproducing methods, respectively.

The operation information may include command information about operation, such as reproduction and stop, or content position information where the command information and the operation are reflected.

The content reproducing unit 25 acquires the content selected by the content selecting unit 15 from the content storage unit 16, reads the reproducing method selected by the content selecting unit 15 from the phone-call-related information acquired from the phone-call-related information reading unit 14, and reproduces the content with the content viewing unit 18, as described in FIG. 2.

The content reproducing unit 25 notifies (transmits to) the opposite party of the content selected by the content selecting unit 15 from the content transmitting unit 22.

If the content of the opposite party is shared, the content received by the content receiving unit 21 is reproduced.

The content reproducing unit 25 notifies the phone-call-related information extracting unit 12 of the operation input from the operation input unit 19 for the content shared and viewed with the opposite party in accordance with the content reproduction position information and transmits the operation to the opposite party from the content operation information transmitting unit 24.

The content reproducing unit 25 notifies the phone-call-related information extracting unit 12 of the operation received by the content operation information receiving unit 23 for the content shared and viewed with the opposite party in accordance with the content reproduction position information and reflects the operation to the reproduction of the content.

The operation input unit 19, the content selecting unit 15, the content viewing unit 18, and the phone-call-related information extracting unit 12 have the same functions as the components described in FIG. 2.

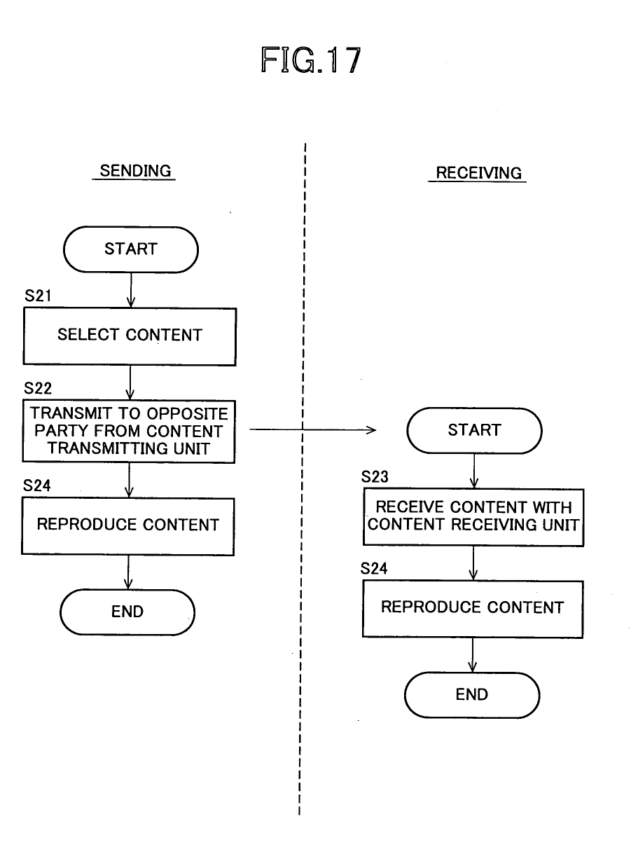

FIG. 17 is a flowchart for describing a process of selecting the content and sharing the selected content with the opposite party during a telephone call and FIG. 17 shows that the content on the sending side is shared on the receiving side.

The content is selected on the sending side by performing the same process as step S1 to step S13 of FIG. 4 on the sending side during a telephone call (step S21). That is, the content reproducing unit 25 acquires the content selected by the user based on the content and the reproducing method thereof selected by the user's content selection operation.

The content reproducing unit 25 transmits the acquired content from the content transmitting unit 22 to the opposite party (step S22). The content reproducing method selected at step S21 may also be transmitted to the opposite party.

The content receiving unit 21 receives the shared content on the receiving side (step S23).

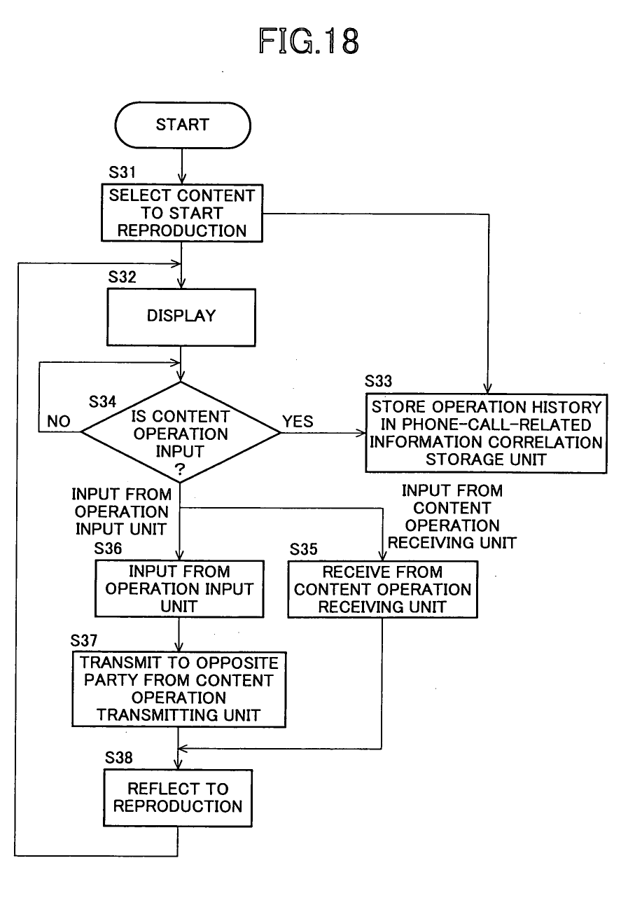

When the reception is completed, reproduction of the content is started on the sending and receiving sides (step S24). The content may not be reproduced at the same clock time or may be reproduced at the same time by exchanging information for the simultaneous reproduction, for example, time information between the sending and receiving sides. A detailed flow (process procedure) of the sharing and reproducing process will be described in FIG. 18.

FIG. 18 is a flowchart for describing a process of storing the phone-call-related information when sharing and viewing the content with the opposite party. This series of processes corresponds to the description of the process performed at step S24 of FIG. 17.

First, the content reproducing unit 25 starts the reproduction of the content transmitted or received at step S22 or step S23 of FIG. 17 in accordance with the process flow from step S14 to step S17 of FIG. 4 (step S31).

When the reproduction is started with the process at step S31, the phone-call-related information is stored in the phone-call-related information correlation storage unit 13 as is the case with the process at step S3 of FIG. 3 (step S33).

The content viewing unit 18 displays the content on the screen as is the case with the process at step S2 of FIG. 3 (step S32).

When the content shared and viewed with the opposite party is operated as is the case with step S4 of FIG. 3 (YES at step S34), the operation history is stored (saved) in the phone-call-related information correlation storage unit 13 (step S33).

If the input operation is the operation (information) received by the content operation information receiving unit 23 (step S35), the content reproducing unit 25 reflects the operation information to the content reproducing process for display as is the case with the process at step S5 of FIG. 3 (step S38).

If the input operation is the operation input from the operation input unit 19 (step S36), the content reproducing unit 25 transmits the input operation information to the opposite party from the content operation information transmitting unit 24 (step S37).

In this flowchart (process procedure), when the operation history is stored in the phone-call-related information correlation storage unit 13, the operation inputs on the sending side and the receiving side may be stored distinctively. As a result, various reproducing methods can be realized and, for example, only the operation performed on the receiving side can be reproduced when the content is viewed again.

Since the content can be shared and viewed while talking on the phone with the opposite party and the operation history can be stored for the operation shared with the opposite party in the phone-call at the time of sharing and viewing the content as described above, various content selecting methods and reproducing methods can be provided to the user when viewing the content again later.

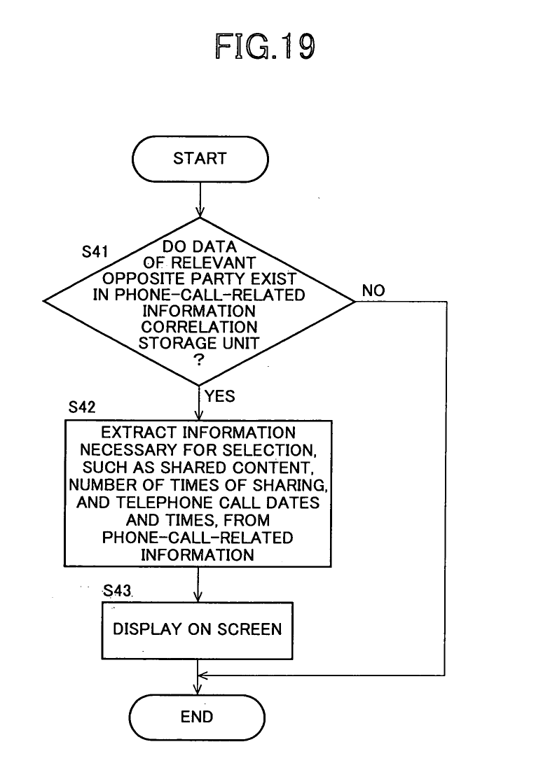

FIG. 19 is a flowchart for describing a process of extracting the content shared with the opposite party from the phone-call-related information correlation storage unit 13 to display the content on the selection screen.

The content selecting unit 15 uses the phone-call-related information reading unit 14 to determine whether the content (data) correlated with the relevant opposite party in the phone-call-related information stored in the phone-call-related information correlation storage unit 13 (step S41).

If the content correlated with the relevant opposite party exits (YES at step S41), the phone-call-related information reading unit 14 reads information necessary for displaying the selection screen, such as the content name, the date and time of the sharing, and the number of times (step S42).

The content selecting unit 15 uses the read phone-call-related information to display the selection screen (step S43).

If the correlated information does not exist (NO at step S41), the content selection screen is not displayed on the screen.

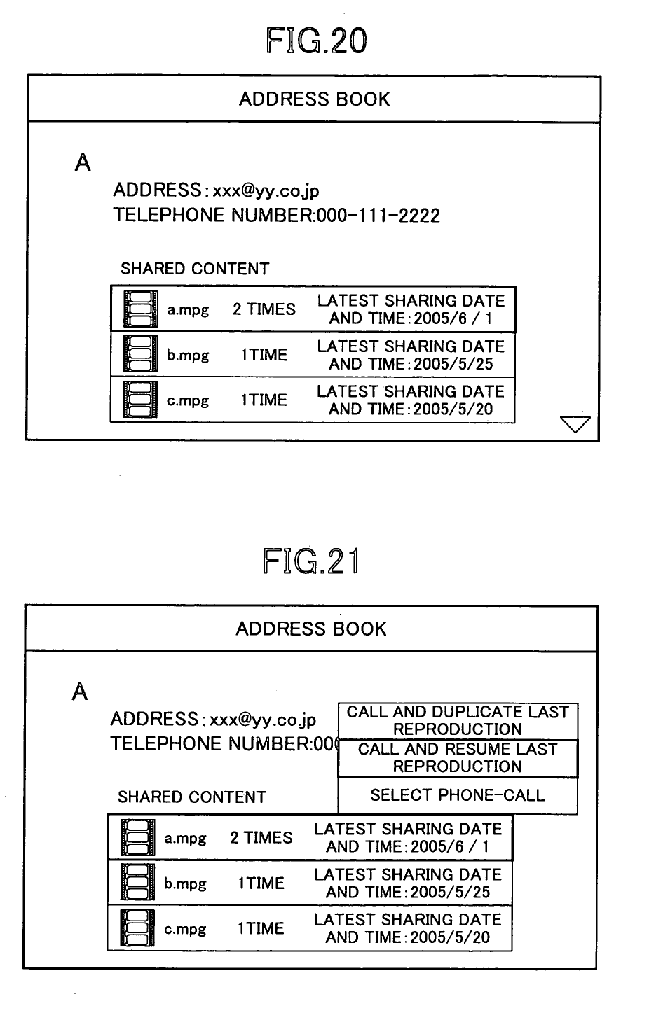

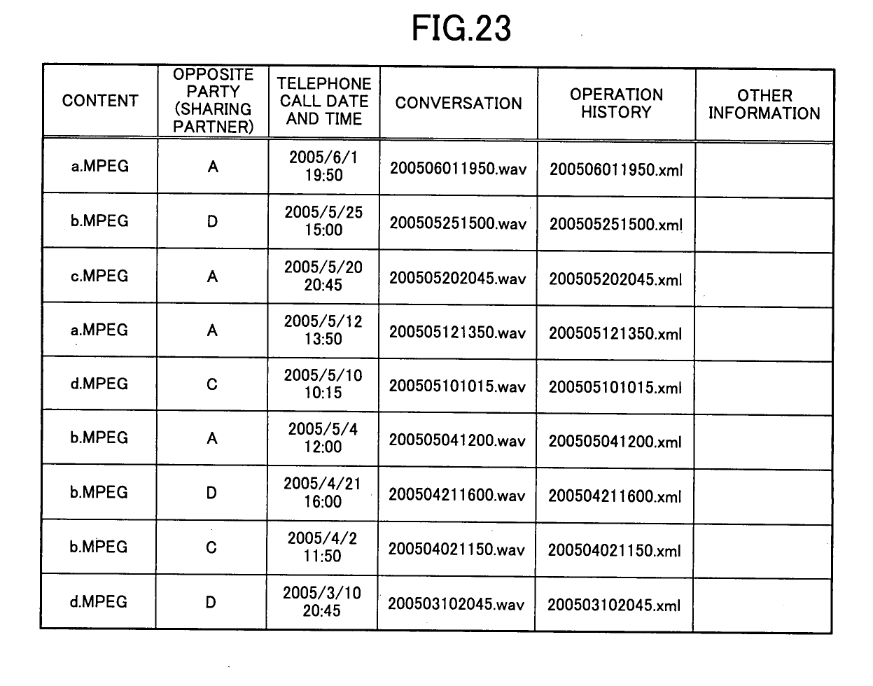

FIGS. 20 and 21 and FIG. 22 show two process procedures of selecting content from the content selection screen displayed in accordance with the flowchart of FIG. 19 when the information (phone-call-related information) shown in FIG. 23 is stored in the phone-call-related information correlation storage unit 13.

FIG. 23 is a diagram for describing the phone-call-related information stored in the phone-call-related information correlation storage unit 13 and illustrates how the phone-call-related information correlation storage unit 13 stores and correlates various pieces of information, i.e., opposite parties (sharing partners) (A, C, D), telephone call dates and times, conversations, operation histories, and other information with content.

Conversations with the opposite parties are stored in wav files with file names of the conversation dates and times, and details of various operations (reproduction, pause, fast-forward, etc.) performed for the content at the time of the telephone calls are stored as the operation histories in xml files with file names of the conversation dates and times.

FIG. 20 is a screen displaying a list of the content shared with an opposite party in an address book screen that displays detailed information (mail address, telephone number, etc.) of a partner (opposite party) stored in the telephone calling unit 11.

By performing the process of step S41 of FIG. 19, the content correlated with an opposite party A is retrieved. Since pieces of content, a.mpg, b.mpg, c.mpg are retrieved as a result, step S42 is performed to extract content names, the numbers of times of the sharing of the content, and recent sharing dates, and a “shared content” list of FIG. 20 is created and displayed.

The displayed content may be sorted and displayed in the order from the latest or oldest sharing date or in the ascending or descending order of the number of times of the sharing.

FIG. 21 shows an example of the selection screen when the a.mpg is selected in FIG. 20. The user can select a reproducing method from: (1) “call and duplicate last reproduction” used for calling A to perform the duplicating reproduction of last viewing of the a.mpg; (2) “call and resume last reproduction” used for calling A to perform the resume reproduction of the continuation of the last viewing of the a.mpg; and (3) “select phone-call” used for calling and viewing the content after selecting the phone-call that the a.mpg was shared and viewed with A.

If “call and resume last reproduction” is selected as shown in FIG. 21, when the telephone calling unit 11 calls and connects to A, the a.mpg is transmitted from the content transmitting unit 22 to A. The reproduction schedule of the resume reproduction is created and reproduced based on an xml file, 200506011950.xml, which is operation history information that stores the history of various operations (reproduction, pause, fast-forward process, etc.) performed for the content when the content (a.mpg) was shared and viewed in the telephone call on Jun. 1, 2005.

The content operation information transmitting unit 24 transmits the information of the operation performed in the reproduction schedule to A. Instead of transmitting the content operation information to A, the created reproduction schedule may be transmitted to perform the reproduction in accordance with the reproduction schedule on the side of A.

If “call and duplicate last reproduction” is selected in FIG. 21, the duplicating reproduction is performed as is the case with the resume reproduction.

If “select phone-call” is selected, with regard to the phone-calls when the a.mpg was shared and viewed with A in the phone-call-related information described in FIG. 23, the phone-calls are sorted and displayed in ascending (or descending) order of dates, etc. When the phone-call is selected, the reproducing methods are displayed. When the reproducing method is selected, the reproduction is performed with the selected reproducing method as described above.

The options may include options for selecting reproducing methods or deletion of the content as shown in FIGS. 11 to 14, other than the options for calling A.

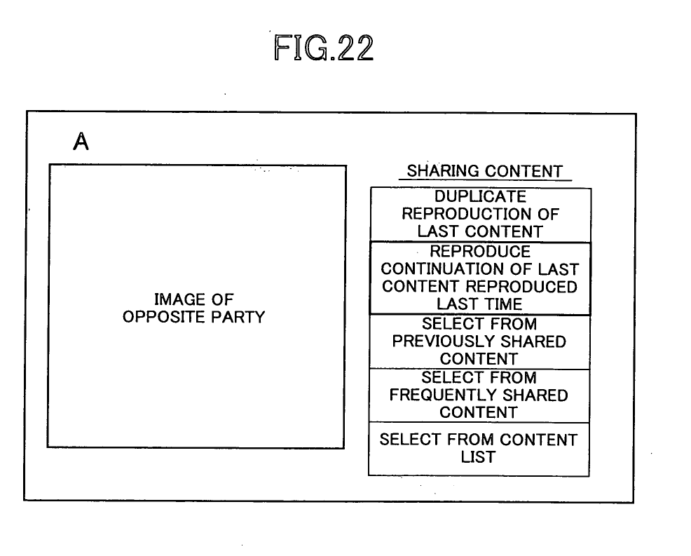

FIG. 22 is a diagram for describing an example of selecting methods of selecting the content in accordance with the flow of FIG. 19 and shows a screen of selecting the content shared and viewed during a telephone call with A.

As is the case with the extraction of the “shared content” displayed on the address book shown in FIG. 20, the content selecting unit 15 uses the phone-call-related information of the content associated with A to display five items, which are: (1) “duplicate reproduction of last content” used for performing the duplicating reproduction of the content shared in the last telephone call with A; (2) “reproduce continuation of last content reproduced last time” used for performing the resume reproduction of the continuation of the content shared in the last telephone call with A; (3) “select from previously shared content” used for selecting the content shared previously with A; (4) “select from frequently shared content” used for selecting the content shared frequently during telephone calls; and (5) “select from content list”. An image of A in the current telephone call is displayed on the left side of the screen.

If “reproduce continuation of last content reproduced last time” is selected as shown in FIG. 22, the resume reproduction is performed by using the operation history information storing the history of various operations (reproduction, pause, fast-forward process, etc.) performed for the content when the content (a.mpg) was shared and viewed in the telephone call on Jun. 1, 2005.

If “duplicate reproduction of last content” is selected, the duplication reproduction is performed based on the operation history information stored when the content (a.mpg) was shared and viewed in the telephone call on Jun. 1, 2005.

If “select from previously shared content” is selected, pieces of the content shared and viewed with A, i.e., a.mpg, b.mpg, and c.mpg are displayed as a list and the reproducing method is selected after the content is selected. If the content was shared and viewed a plurality of times, the phone-call is selected and the reproducing method is finally selected.

If “select from frequently shared content” is selected, pieces of the content are displayed in the order of the number of times of the sharing and viewing from the information shown in FIG. 23. In this example, since it can be seen that the b.mpg, a.mpg, d.mpg, and c.mpg are shared four times, two times, two times, and one time, respectively, pieces of the content are displayed in this order. When the content is selected, the reproducing method is selected, or the phone-call is selected and the reproducing method is selected, to reproduce the content in accordance with the selected method.

Although only four pieces of the content are used in this example, if more pieces of the content exist, for example, five pieces may be displayed each time in the order from the largest number of times of the sharing and viewing.

If “select from content list” is selected, the desired content is selected and reproduced from the “content list” as described in FIGS. 11 to 14.

As described above, by storing content viewed during a telephone call and phone-call-related information in a correlated manner and by using the phone-call-related information, various selecting methods and reproducing methods can be realized to select and view the content efficiently. The user can remember details of conversations performed in the phone-call while viewing the content (content viewed during the telephone call), the story associated with the content, etc.

Although the embodiments and examples of the present invention have been described as above, the embodiments and examples disclosed here should be considered illustrative rather than restrictive in all respects. The scope of the present invention is indicated by claims and includes all the modifications within the spirit and range equivalent to the claims.

As described above, according to the present invention, by storing and correlating various pieces of phone-call-related information with content when viewing the content during a telephone call, the content can be efficiently selected or viewed based on the form of the viewing during the previous telephone call when the content is viewed again.

1. An information processing apparatus comprising: a telephone calling unit that uses a call to perform a telephone call; a content viewing unit that is used for viewing content; a phone-call-related information correlation storage unit that stores content viewed at the time of a telephone call and phone-call-related information in a correlated manner; and a phone-call-related information outputting unit that outputs the phone-call-related information correlated with the content when viewing the content stored and correlated with the phone-call-related information stored in the phone-call-related information correlation storage unit.

2. The information processing apparatus of claim 1, wherein the phone-call-related information is information relating to an opposite party.

3. The information processing apparatus of claim 1, wherein the phone-call-related information is information relating to a clock time of the telephone call.

4. The information processing apparatus of claim 1, wherein the phone-call-related information is information relating to details of the telephone call.

5. An information processing apparatus comprising: a telephone calling unit that uses a call to perform a telephone call; a content viewing unit that is used for viewing content; an operation information correlation storage unit that stores content viewed at the time of a telephone call and operation information describing details of operation performed for the content viewed at the time of the telephone call in a correlated manner; and a content reproducing unit that reproduces the content depending on the operation information correlated with the content when viewing the content stored and correlated with the operation information stored in the operation information correlation storage unit.

6. The information processing apparatus of claim 5, wherein the operation information describing details of operation performed for the content includes a history of operation performed for the content at the time of a telephone call to apply the operation based on the operation history to reproduce the content when viewing the content stored and correlated with the operation information stored in the operation information correlation storage unit.

7. The information processing apparatus of claim 5, wherein the operation information describing details of operation performed for the content during a telephone call includes operation input by a user of the information processing apparatus to apply the operation to the content and to notify the opposite party of the operation information.

8. The information processing apparatus of claim 5, wherein the operation information describing details of operation performed for the content during a telephone call includes operation information notified from the opposite party.

9. An information processing apparatus comprising: a telephone calling unit that uses a call to perform a telephone call; a content viewing unit that is used for viewing content; a correlation storage unit that stores content viewed at the time of a telephone call and phone-call-related information in a correlated manner; and an extracting unit that extracts content corresponding to the phone-call-related information depending on the phone-call-related information.

10. An information processing apparatus comprising: a telephone calling unit that uses a call to perform a telephone call; a content viewing unit that is used for viewing content; a correlation storage unit that stores content viewed at the time of a telephone call and phone-call-related information in a correlated manner; and an extracting unit that extracts the phone-call-related information correlated with the content depending on the content.

11. The information processing apparatus of claim 9, comprising a selecting unit that selects the content extracted by the extracting unit depending on the phone-call-related information and a reproducing unit that reproduce the content selected by the selecting unit.

12. The information processing apparatus of claim 9, wherein the phone-call-related information is information relating to an opposite party.

13. The information processing apparatus of claim 9, wherein the phone-call-related information is information relating to a clock time of the telephone call.

14. The information processing apparatus of claim 9, wherein the phone-call-related information is information relating to details of the telephone call.

15. An information processing method comprising: a telephone calling step of using a call to perform a telephone call; a content viewing step of viewing content; a phone-call-related information correlation storage step of storing content viewed at the time of a telephone call and phone-call-related information in a correlated manner; and a phone-call-related information output step of outputting the phone-call-related information correlated with the content when viewing the content stored and correlated with the phone-call-related information stored at the phone-call-related information correlation storage step.

16. An information processing method comprising: a telephone calling step of using a call to perform a telephone call; a content viewing step of viewing content; an operation information correlation storage step of storing content viewed at the time of a telephone call and operation information describing details of operation performed for the content viewed at the time of the telephone call in a correlated manner; and a content reproducing step of reproducing the content depending on the operation information correlated with the content when viewing the content stored and correlated with the operation information stored at the operation information correlation storage step.

17. An information processing method comprising: a telephone calling step of using a call to perform a telephone call; a content viewing step of viewing content, a correlation storage step of storing content viewed at the time of a telephone call and phone-call-related information in a correlated manner; and an extracting step of extracting content corresponding to the phone-call-related information depending on the phone-call-related information.

18. An information processing method comprising: a telephone calling step of using a call to perform a telephone call; a content viewing step of viewing content; a correlation storage step of storing content viewed at the time of a telephone call and phone-call-related information in a correlated manner; and an extracting step of extracting the phone-call-related information correlated with the content depending on the content.

19. The information processing method of claim 17, comprising a selecting step of selecting the content extracted at the extracting step depending on the phone-call-related information and a reproducing step of reproducing the content selected at the selecting step.

20. A program for executing the information processing method claim 15 with a computer.
